(19) United States
(12) Patent Application Publication
(10) Pub. No.: US 2024/0381870 A1
(43) Pub. Date: Nov. 21, 2024

(54) FUNGICIDAL COMBINATION FOR PREVENTING AND CONTROLLING WHEAT SCAB AND STEM BASE ROT DISEASE

(71) Applicant: Institute of Plant Protection and Agro-products Safety, Anhui Academy of Agricultural Sciences, Hefei (CN)

(72) Inventors: Wei Zhao, Hefei (CN); Rende Qi, Hefei (CN); Yuankai Chi, Hefei (CN); Amei Xu, Hefei (CN); Tao Wang, Hefei (CN); Shun Cao, Hefei (CN); Yanqiu He, Hefei (CN)

(21) Appl. No.: 18/788,759

(22) Filed: Jul. 30, 2024

(30) Foreign Application Priority Data
Jan. 23, 2024 (CN) 202410096783.1

(51) Int. Cl. A01N 43/50; A01N 43/40; A01P 3/00

(52) U.S. Cl. CPC A01N 43/50; A01N 43/40; A01P 3/00

(57) ABSTRACT

A fungicide composition for effectively preventing and controlling wheat scab is disclosed. The active ingredient is composed of fungicides cyclobutrifluram and prochloraz, and an appropriate amount of agricultural fungicide additives are added to make a commonly used dosage form for crop disease prevention and control. The present disclosure has a higher prevention and control effect on crop fungal diseases. There is a significant synergistic effect between the two pesticides, and it has the effect of expanding spectrum of disease prevention, and achieves comprehensive prevention and control of multiple diseases. It can significantly reduce pesticide application, effectively reduce ecological damage and environmental pollution, and improve crop yield and quality; In the present disclosure, cyclobutrifluram and prochloraz are both of low toxicity and are safe for humans, animals, beneficial organisms, and the environment; The present disclosure can delay the resistance of fungi to a single agent.

### TECHNICAL FIELD

The present disclosure belongs to the field of agricultural fungicides and specifically relates to a fungicidal combination formed by different ratios of cyclobutrifluram and prochloraz. By adding an appropriate amount of additives, commonly used dosage forms for crop disease prevention and control are made, which efficiently prevents wheat scab and stem base rot disease caused by Fusarium, and simultaneously prevents wheat rust, wheat powdery mildew, wheat sheath blight, wheat leaf blight, wheat cyst nematode disease, and other common fungal diseases in crops.

### BACKGROUND ART

Wheat scab is also called wheat ear blight, rotten wheat head, or red wheat head. According to reports, there are more than 20 types of Fusarium that can cause wheat scab both domestically and internationally. In China, Fusarium graminearum and F. avenaceum are the dominant species of wheat scab. In recent years, Fusarium pseudogramineaqum has gradually risen to become one of the dominant fungal populations in the Huanghuai wheat region. Wheat scab is common in major wheat growing regions around the world, and has a significant impact on wheat yield and quality. Wheat scab is common and severe in China. In history, the middle and lower reaches of the Yangtze River and the Jianghuai wheat region were frequent areas of wheat scab, with an annual occurrence area of 40-50 million mu. In recent years, due to various factors such as climate change, farming systems, and straw returning, wheat scab has been migrating to the north and west and has been increasing year by year, gradually becoming one of the main diseases in wheat production areas. In normal years, the loss caused by wheat scab is 10% to 20%, and in years of scab outbreak, the loss can reach 20% to 40%, and even some fields have no harvest. In addition to affecting yield, infected wheat ears can also produce various toxins, such as DON toxin, ZEN toxin, etc., which can cause dizziness and vomiting in consumers, and easily lead to miscarriage in pregnant humans and animals. Moreover, this type of toxin is exceptionally stable and not easily degraded under high temperatures. The contaminated wheat grains used as animal feed can ultimately be transmitted to the top of the food chain in humans. After the toxin accumulates in the human liver year-round, it is prone to cause liver carcinogenesis. Therefore, from the perspective of food safety, according to China's regulations, if the rate of wheat scab in wheat grains exceeds 4% and the toxin content exceeds 1 μg/mL, it is considered as an unqualified product and will not be purchased. Therefore, the efficient and safe prevention and control of wheat scab is a major issue related to China's food security.

The Fusarium, which causes wheat scab, can infect wheat plants at various growth stages. Seeds carrying fungi or soil disease residues carrying fungi can cause seedling withering, which is prone to occur in spring wheat areas. Infected wheat seedlings weaken in growth, and the roots and leaves rot in a watery manner. Gradually, the entire wheat plant withers and dies. When the environment is humid, there is a pink mold layer remaining in the soil. The wheat stem base rot disease caused by Fusarium can occur throughout the entire growth period, among which Fusarium pseudogramineaqum has the strongest pathogenicity. In the rainy spring season, pathogens can infect the wheat stem base, causing it to become brown and rot, unable to be uprooted, and the plant to wilt and die. Before and after heading, wheat is susceptible to infection by Fusarium graminearum and other fungi on the stems. There are brown patches between the internodes and leaf sheaths, and the parts above the diseased area wither and turn yellow, causing the wheat to fail to head or die after heading, also known as stem rot. When wheat enters the flowering stage, the wheat ear is the main site of wheat scab. The infected wheat ear has a light brown water stain like disease spot at the base of the glume, which later expands into a yellow brown disease spot, blocking water and nutrient transport, causing the wheat ear to wither, and even leading to the death of the entire plant. Under suitable conditions, such as high air humidity and suitable temperature, the infected area of wheat will produce a red conidiospore layer. During wind and rain weather, conidiospore can spread with rainwater and become a secondary source of infection. Fusarium can invade the ear axis and block the vascular bundle system, causing the entire wheat ear to appear green and withered, resulting in dry withered grains. If it invades the neck node of the ear, the whole ear will wither and yellow, not bear fruit, and seriously affect yield. When the air humidity is low and sunlight is shining, the condition is suppressed, and only the spikelets appear withered and yellow. In the later stage of the occurrence of wheat scab, when encountering cloudy and rainy weather, blue black glossy wheat scab spore shells will be produced on the mold layer of the affected area.

The prevention and control of wheat scab is a systematic process, and the first step is to select varieties that are resistant and tolerant to scab; secondly, deep cultivation before sowing can reduce the residual pathogens in the soil; using efficient seed coating agents to mix seeds; timely late broadcasting; avoiding dense planting and maintain ventilation and light transmission in the field; trenching in the field and timely drainage can reduce field humidity. But the most important thing is still to use chemical agents for effective prevention and control at the appropriate time. Wheat scab can be prevented but not treated. Once the pathogen invades the plant, it not only rapidly infects and causes disease, but also produces a large amount of toxins, seriously affecting the quality of wheat. Therefore, selecting the appropriate type of pesticide and sufficient effective dosage during the initial stage of wheat flowering is the key to ensuring the effectiveness of prevention and control. However, the long-term use of a single agent and unreasonable application methods make it easy for pathogens to develop resistance, leading to decreased efficacy and disease outbreaks, thereby increasing drug use, forming a vicious cycle, increasing drug costs, and exacerbating environmental pollution. This is also a major challenge in chemical control. For example, in Jiangsu, Anhui and other regions, wheat Fusarium has developed significant resistance to benzimidazole fungicides such as carbendazim. Therefore, the rational combination of pesticides with different chemical structures and mechanisms of action is an effective measure to overcome the occurrence and development of drug resistance. It can improve performance, reduce the dosage per unit area, and enhance the effectiveness of prevention and control.

Cyclobutrifluram is a novel succinate dehydrogenase inhibitor (SDHI) developed by Syngenta, with the molecular formula C₁₇H₁₃Cl₂F₃N₂O and the structural formula shown in FIG. 1. Cyclobutrifluram has a good fungicidal effect on Fusarium and is also an efficient nematicide. It mainly acts on respiratory chain electron transfer complex II, blocks energy metabolism, and has effects such as protection, treatment, systemic absorption, and conduction. Therefore, it can be developed and utilized as a new type of agent for wheat scab prevention and control. The structural formula of cyclobutrifluram is as follows:

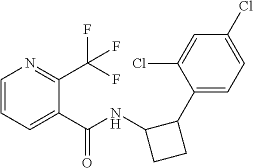 [SMILES: O=C(NC1CCC1c1ccc(Cl)cc1Cl)c1cccnc1C(F)(F)F]

Prochloraz belongs to the imidazole class of fungicides, with the chemical formula C₁₅H₁₆Cl₃N₃O₂. Prochloraz mainly affects the formation of fungal cell walls by hindering the biosynthesis of fungal ergosterol, and has significant control effects on various fungal diseases that harm crops. It can also be mixed with most fungicides, insecticides, and herbicides to achieve the goal of enhancing efficiency and expanding the scope of action. It has a therapeutic and eradication effect on various diseases on field crops, fruits and vegetables, turf, and ornamental plants. The structural formula of prochloraz is as follows:

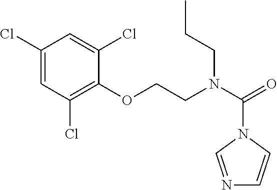 [SMILES: CCCN(CCOc1c(Cl)cc(Cl)cc1Cl)C(=O)n1ccnc1]

### SUMMARY

The present disclosure provides two fungicides with different prevention and control mechanisms and different action sites against Fusarium. The combination formed by different ratios has a significant synergistic and inhibitory effect on Fusarium. The processed preparation not only efficiently prevents and controls wheat scab and wheat stem base rot disease, but also increases the disease resistance spectrum. It can simultaneously prevent and control crop Fusarium oxysporum root rot and crop root knot nematode diseases, which provides an efficient, low toxicity, and broad-spectrum formula combination for comprehensive prevention and control of crop diseases.

The technical solution of the present disclosure is as follows:

A fungicidal combination for preventing and controlling wheat scab is provided, which is composed of cyclobutrifluram and prochloraz.

The characteristic of the fungicide is that the mass ratio of cyclobutrifluram to prochloraz is 20:1 to 1:20. When used for the prevention and control of Fusarium graminearum, the mass ratio of cyclobutrifluram to prochloraz is 1:1 to 1:5; when used for the prevention and control of Fusarium pseudogramineaqum, the mass ratio of cyclobutrifluram to prochloraz is 5:1 to 1:5.

The effective components of cyclobutrifluram and prochloraz account for 1% to 80% of the total mass of the fungicidal composition. By adding an appropriate amount of agricultural fungicidal additives, suspension agents, wettable powders, microcapsules, water dispersible granules or suspended seed coatings are prepared, which can effectively prevent and control wheat scab. At the same time, different dosage forms are used on different crops to prevent and control cyst nematode disease, root knot nematode disease, sickle root rot disease, stem base rot disease, and other common fungal diseases.

By adopting the above technical solution, the present disclosure has the following beneficial effects:

The present disclosure reports for the first time that cyclobutrifluram has a significant inhibitory effect on Fusarium, and the two types of compounds have different structural types and different action sites. When combined in a certain proportion, they have a significant synergistic effect. This combination not only increases the inhibitory effect but also increases the disease resistance spectrum. By adding efficient additives, it can be processed into easily usable suspension agents, wettable powders, microcapsules, water dispersible granules or suspended seed coatings in production, with high biological activity and increased disease prevention. It has good prevention and control effects on commonly occurring nematode and fungal diseases in crops in production. Moreover, after compounding and increasing efficiency, the total amount of medication per unit area is decreased, the frequency of medication is decreased, the cost of medication is reduced, the production and development of pathogen resistance is delayed, the service life of each component in the fungicidal composition is extended, and the safety of crops is good. This achieves the purpose of economy, efficiency, and environmental protection.

### DETAILED DESCRIPTION OF THE EMBODIMENTS

The following will provide further explanation of the present disclosure in conjunction with specific embodiments.

### Embodiment 1: Indoor Toxicity Determination of Cyclobutrifluram and Prochloraz Against Fusarium graminearum and Fusarium pseudogramineaqum

A detailed analysis of the fungicidal properties of cyclobutrifluram and prochloraz was performed. Firstly, the EC₅₀ (drug safety index) of two single compounds, cyclobutrifluram and prochloraz (hereinafter referred to as the drug) was measured. Based on the EC₅₀ of the two single drugs, the combination ratio of the two drugs was set using the Wadley method, and the SR value of the Wadley enhancement coefficient was calculated.

The experimental targets were Fusarium graminearum and Fusarium pseudogramineaqum. The cyclobutrifluram and prochloraz were selected, and the PDA solid medium were selected, and the required liquid chemicals plates were prepared at about 18 ml per plate. The mycelium blocks with 5 mm diameter were prepared at the edge of pre cultured colonies using a sterilized punch, transferred to different culture media plates, and cultivated at 25° C. The experiment used the mycelial growth assay method to prepare drug containing culture media according to different treatments. The mycelium blocks with 5 mm diameter were prepared at the edge of pre cultured colonies using a sterilized punch and transferred to different culture media plates with different drug contents. The colony diameter was measured using the cross over method, and the colony diameter (mm) was measured. The growth inhibition rate was calculated using the following formula:

$$Mycelial growth inhibition rate \% = ( 1 - colony diameter in drug treatment - 5 / control colon diameter - 5 ) \times 100$$

The mycelial growth inhibition rate was converted to the inhibition probability value (y), and the drug concentration was converted to the concentration logarithm (x). The concentration logarithm was used as the x-axis and the probability value was used as the y-axis to create a toxicity regression line. The toxicity regression equation of a single agent of cyclobutrifluram and prochloraz and a mixed agent of cyclobutrifluram and prochloraz against the pathogen were obtained, and the EC₅₀ value and correlation coefficient r were calculated.

According to the Wadley method to evaluate the interaction of the mixed agent, the calculation formula is as follows:

$${EC}_{50} ( theoretical value ) = ( a + b ) / ( a / {EC}_{50} a + b / {EC}_{50} b ) ,$$

$$SR = {EC}_{50} ( theoretical value ) / {EC}_{50} ( actual value ) .$$

Among them, a and b are the proportions of each component in the mixed agent, and the SR value is used to analyze the mixing effect. If SR≤0.5, the mixed agent of the two drugs has an antagonistic effect; if SR=0.5-1.5, the mixed agent of the two drugs has an additive effect; if SR≥1.5, the mixed agent of the two drugs has a synergistic effect.

TABLE 1
Toxicity test results of single and mixed agent of cyclobutrifluram
and prochloraz against Fusarium graminearum

| | | | | EC₅₀ | |
|---|---|---|---|---|---|
| | | Correlation | | (theoretical | |
| Proportion (P:B) | Regression equation | coefficient (r) | EC₅₀ ppm | value) ppm | SR |
| Cyclobutrifluram(C) | y = 5.5877 + 1.3773x | 0.9939 | 0.3744 | | |
| Prochloraz(P) | y = 5.7421 + 1.2913x | 0.9904 | 0.2663 | | |
| 20:1 | y = 5.6074 + 1.2261x | 0.9931 | 0.3196 | 0.3673 | 1.1492 |
| 10:1 | y = 5.7802 + 1.2909x | 0.9933 | 0.2486 | 0.3611 | 1.4524 |
| 5:1 | y = 5.8496 + 1.3211x | 0.9962 | 0.2274 | 0.3507 | 1.5421 |
| 1:1 | y = 5.985 + 1.3587x | 0.9971 | 0.1884 | 0.3112 | 1.652 |
| 1:5 | y = 6.1067 + 1.4619x | 0.9989 | 0.175 | 0.2798 | 1.5986 |
| 1:10 | y = 6.0168 + 1.4053x | 0.9986 | 0.189 | 0.2735 | 1.447 |
| 1:20 | y = 5.9631 + 1.4487x | 0.9966 | 0.2164 | 0.27 | 1.2477 |

From the above table, it can be seen that the antifungal effects of different ratios of cyclobutrifiuram and prochloraz on Fusarium graminearum causing wheat scab were different. The experimental results show that cyclobutrifluram and prochloraz have an additive effect in the ratio range of 20:1 to 1:20, and their ratio has a synergistic effect in the range of 5:1 to 1:5.

TABLE 2
Toxicity test results of single and mixed agent of cyclobutrifluram
and prochloraz against Fusarium pseudogramineaqum

| | | | | EC₅₀ | |
|---|---|---|---|---|---|
| | | Correlation | | (theoretical | |
| Proportion (P:B) | Regression equation | coefficient (r) | EC₅₀ ppm | value) ppm | SR |
| Cyclobutrifluram(C) | y = 6.065 + 1.1909x | 0.9975 | 0.1276 | | |
| Prochloraz(P) | y = 5.9229 + 1.4507x | 0.997 | 0.2311 | | |
| 20:1 | y = 6.0443 + 1.1942x | 0.993 | 0.1335 | 0.1304 | 0.9776 |
| 10:1 | y = 6.1431 + 1.2727x | 0.9835 | 0.1264 | 0.133 | 1.0523 |
| 5:1 | y = 6.3385 + 1.265x | 0.9929 | 0.0875 | 0.1379 | 1.5759 |
| 1:1 | y = 6.306 + 1.1812x | 0.9976 | 0.0784 | 0.1644 | 2.0972 |
| 1:5 | y = 6.1012 + 1.228x | 0.9963 | 0.1269 | 0.2036 | 1.6042 |
| 1:10 | y = 5.8981 + 1.1247x | 0.9984 | 0.159 | 0.2125 | 1.3536 |
| 1:20 | y = 5.8528 + 1.107x | 0.9965 | 0.1697 | 0.2225 | 1.3112 |

From the above table, it can be seen that the antifungal effects of different ratios of cyclobutrifluram and prochloraz on Fusarium pseudogramineaqum causing wheat stem base rot disease were different. The experimental results show that cyclobutrifluram and prochloraz have an additive effect in the ratio range of 20:1 to 1:20, and their ratio has a synergistic effect in the range of 5:1 to 1:5.

The indoor combined action test results showed that the composition of cyclobutrifluram and prochloraz had a good growth inhibition effect on Fusarium graminearum and Fusarium pseudogramineaqum. There was a significant additive or synergistic effect between the two components in different ratios, which increased the antifungal effect. In the present disclosure, cyclobutrifluram and prochloraz are both of low toxicity and safe for humans, animals, beneficial organisms, and the environment. Cyclobutrifluram and prochloraz belong to different types of fungicides with different modes of action. There is no cross-resistance between the two, and there are also differences in their fungicidal spectrum. The mixed use of the two components can delay the resistance of the fungi to a single agent, and increase the spectrum of disease prevention in crops at the same time, thereby achieving the purpose of both prevention and drug reduction.

### Embodiment 2: Formulation Implementation

### Example 1 of Formulation Implementation

Preparation method of 24% cyclobutrifluram·prochloraz water dispersible granules: by mass percentage.

Cyclobutrifluram: 20%; Prochloraz: 4%; Sodium lignosulfonate: 6%; Polyvinyl alcohol: 4%; Ammonium sulfate: 8%; White carbon black: 10%; Kaolin: surplus;

Preparation method: The above-mentioned components are added into a mixer at the formulation ratio and are uniformly mixed, then air-flow crushing is performed, a small amount of purified water is added after the completion of the crushing, and the mixture is fully stirred until uniform, then extruding, pelletizing and drying are performed to obtain a water dispersible granule product.

### Example 2 of Formulation Implementation

Preparation method of 30% cyclobutrifluram·prochloraz suspension: by mass percentage.

Cyclobutrifluram: 15%; Prochloraz: 15%; Calcium lignosulfonate: 6%; Alkyl phenol polyoxyethylene phosphate ester: 4%; Xanthan gum: 0.1%; Organic silicon defoamer: 0.3%; water: surplus.

Preparation method: According to the formulation, the above components are weighed in the proportion, added into a ball mill for ball milling for 30 min, filtered, and extracted into a dispersion tank for high-speed shearing for 3 min, and then fully ground by a sand mill, the diameter of solid component particles is controlled to be within 2 microns, and after the grinding is finished, the mixture is stirred until uniform, so as to obtain a suspension product.

### Example 3 of Formulation Implementation

Preparation method of 30% cyclobutrifluram·prochloraz water dispersible granules: by mass percentage.

Cyclobutrifluram: 5%; Prochloraz: 25%; Sodium lignosulfonate: 6%; Polyvinyl alcohol: 4%; Ammonium sulfate: 8%; White carbon black: 10%; Kaolin: surplus;

Preparation method: The above-mentioned components are added into a mixer at the formulation ratio and are uniformly mixed, then air-flow crushing is performed, a small amount of purified water is added after the completion of the crushing, and the mixture is fully stirred until uniform, then extruding, pelletizing and drying are performed to obtain a water dispersible granule product.

### Example 4 of Formulation Implementation

Preparation of 12% cyclobutrifluram·prochloraz suspension seed coatings: by mass percentage.

Cyclobutrifluram 10%, prochloraz 2%, xanthan gum 3%, dispersant FS3000: 8%, 5 sodium dodecyl sulfate 4%, sodium lignosulfonate 3%, glycerol 3%, bentonite 5%, Erit anhydrous fast T: 2%, film-forming agent polyvinyl alcohol: 3%, dye: 2%, water: surplus.

Preparation method: According to the formulation, the above components (except the film-forming agent and the dye) are weighed in the proportion, added to a ball mill for ball milling for 60 min, filtered, and extracted into a dispersion tank for high-speed shearing for 3 min and fully ground by a sand mill, the diameter of solid component particles is controlled to be within 1 μm, after the grinding is finished, the mixture is stirred until uniform, and the film-forming agent and the dye are added to obtain the suspended seed coating product.

### Embodiment 3: Field Control Experiment of Cyclobutrifluram and Prochloraz on Wheat Scab

Wheat scab control experiments were conducted in different regions in 2020 and 2021. The experimental data for the year 2021 are summarized as follows. The experiments were conducted using the following formulations: 30% cyclobutrifluram·prochloraz suspension in example 2 of formulation implementation, 20% cyclobutrifluram suspension, 45% prochloraz water emulsion, and 40% carbendazim suspension. Experimental site 1 was located in Baihu Farm, Lujiang County. The wheat variety was “Ningmai 13”, rice stubble, and the water consumption was 30 kilograms per mu. The first application of the drug was after the wheat grows and blooms, and the second application was 5 days later. The disease investigation was conducted 20 days after the last application (Table 3).

TABLE 3
Control effects of different compound formulations on wheat scab in rice
stubble (Ningmai 13)

| | | | | | Control | | Control |
|---|---|---|---|---|---|---|---|
| | | | | | effect of | | effect of |
| | | First | Second | Diseased | diseased | | disease |
| Control | | dose | dose | ear rate | ear rate | Disease | index |
| targets | Processing agents | (g.a.i/ha) | (g.a.i/ha) | (%) | (%) | index | (%) |
| Wheat | 30% | 150 | 200 | 11.35 | 85.64 | 8.51 | 87.44 |
| scab | cyclobutrifluram • | | | | | | |
| | prochloraz | | | | | | |
| | suspension | | | | | | |
| | 20% | 150 | 200 | 34.51 | 56.33 | 22.71 | 66.48 |
| | cyclobutrifluram | | | | | | |
| | suspension | | | | | | |
| | 45% prochloraz | 150 | 200 | 43.16 | 45.38 | 32.5 | 52.03 |
| | water emulsion | | | | | | |
| | 40% carbendazim | 150 | 200 | 59.27 | 24.99 | 43.04 | 36.47 |
| | suspension | | | | | | |
| | Blank control | — | — | 79.02 | — | 67.75 | — |

Experimental site 2 was located in Yingdong District, Fuyang City. The wheat variety was “Anke 1303”, dry crop wheat, and the water consumption was 30 kilograms per mu. The application of the drug was after the wheat grows and blooms. The disease investigation was conducted 20 days after the application of the drug (Table 4)

TABLE 4
Control effects of different compound formulations on
wheat scab (Anke 1303)

| | | | | Control | | Control |
|---|---|---|---|---|---|---|
| | | | | effect of | | effect of |
| | | | Diseased | diseased | | disease |
| | Processing | | ear rate | ear rate | | index |
| Controltargets | agents | Dose (g.a.i/ha) | (%) | (%) | Disease index | (%) |
| Wheat | 30% | 200 | 2.5 | 93.03 | 1.83 | 93.61 |
| scab | cyclobutrifluram · | | | | | |
| | prochloraz | | | | | |
| | suspension | | | | | |
| | 20% | 200 | 8.91 | 75.17 | 5.67 | 80.20 |
| | cyclobutrifluram | | | | | |
| | suspension | | | | | |
| | 45% | 200 | 12.3 | 65.73 | 10.5 | 63.34 |
| | prochloraz | | | | | |
| | water | | | | | |
| | emulsion | | | | | |
| | 40% | 200 | 22.37 | 37.67 | 18.65 | 34.88 |
| | carbendazim | | | | | |
| | suspension | | | | | |
| | Blank control | — | 35.89 | — | 28.64 | — |

The results of field experiments showed that cyclobutrifluram and prochloraz had a significant control effect on wheat scab, and the control effect was significantly better than that of carbendazim. The pesticide formulation formed by the combination of synergistic ratios had a better overall control effect on wheat scab, and the control effect was higher than that of a single agent. According to field investigations, within the experimental dose range, crop growth was normal, and no plant damage or abnormal phenomena were observed, which was safe for wheat.

### Embodiment 4: Field Control Experiment of Cyclobutrifluram and Prochloraz on Wheat Stem Base Rot Disease

Wheat stem base rot disease control experiments were conducted in 2020 and 2021. The experimental data for the year 2021 are summarized as follows. The experiments were conducted using the following formulations: 12% cyclobutrifluram·prochloraz suspension seed coating in example 4 of formulation implementation, 20% cyclobutrifluram suspension seed coating, 20% prochloraz suspension seed coating, and 15% carbendazim·fipronil suspension seed coating. The experimental site was located in Liuhu Farm, Suixi County. The wheat variety is “Quanmai 725”. The dosage of the preparation was 1:400 by weight to the seeds for seed coating, and the drug was diluted into a drug solution. The final dosage of drug solution and the dosage of seeds was 1 liter of drug solution to coat 100 kg wheat seeds, and then sow directly after shade drying. The disease investigation was conducted after jointing and booting (Table 5).

TABLE 5
Control effects of different compound formulations
on wheat stem base rot disease (Quanmai 725)

| | | Seed | | | | Control |
|---|---|---|---|---|---|---|
| | | coating, | Disease | | | effect of |
| | | agent (g): | rate | Control effect | | disease |
| Control targets | Processing agents | seed (g) | (%) | (%) | Disease index | index (%) |
| Wheat | 12% | 1:400 | 9.82 | 75.94 | 2.61 | 88.64 |
| stem base | cyclobutrifluram · | | | | | |
| rot disease | prochloraz | | | | | |
| | suspension seed | | | | | |
| | coating | | | | | |
| | 20% | 1:400 | 15.73 | 61.44 | 6.29 | 72.64 |
| | cyclobutrifluram | | | | | |
| | suspension seed | | | | | |
| | coating | | | | | |
| | 20% Prochloraz | 1:400 | 19.80 | 51.48 | 10.37 | 54.86 |
| | suspension seed | | | | | |
| | coating | | | | | |
| | 15% carbendazim · | 1:400 | 26.57 | 34.89 | 15.03 | 34.57 |
| | fipronil | | | | | |
| | suspension seed | | | | | |
| | coating | | | | | |
| | Blank control | — | 40.81 | — | 22.97 | — |

The results of field experiments showed that cyclobutrifluram and prochloraz had a significant control effect on wheat stem base rot disease, and the control effect was significantly better than that of carbendazim·fipronil suspension seed coating. The pesticide formulation formed by the combination of synergistic ratios had a better overall control effect on wheat stem base rot disease, and the control effect was higher than that of a single agent. According to field investigations, within the experimental dose range, crop growth was normal, and no plant damage or abnormal phenomena were observed, which was safe for wheat.

Finally, it should be noted that the above listed embodiments are only a few specific embodiments of the present disclosure. Obviously, the present disclosure is not limited to the above embodiments and can have many variations. All deformations that ordinary technical personnel in this field can directly derive or associate from the disclosed content of the present disclosure are considered within the scope of protection of the present disclosure.

What is claimed is:

1. A fungicidal composition for preventing and controlling wheat scab and stem base rot disease caused by Fusarium, wherein an active ingredient is composed of cyclobutrifluram and prochloraz, with a mass ratio of 20:1 to 1:20 for cyclobutrifluram and prochloraz.

2. The fungicidal composition according to claim 1, wherein a mass ratio of cyclobutrifluram and prochloraz is 5:1 to 1:5.

3. The fungicidal composition according to claim 1, wherein the active ingredient accounts for 1% to 80% of a total mass of the fungicidal composition, and is prepared into suspension agents, wettable powders, microcapsules, water dispersible granules or suspended seed coatings by adding an appropriate amount of agricultural fungicidal additives.

4. A use of the fungicidal composition according to any one of claim 1 for preventing and controlling crop diseases.

5. The use according to claim 4, wherein the use is used for effectively preventing and controlling wheat scab and wheat stem rot stem base rot disease caused by Fusarium, while also preventing wheat rust, wheat powdery mildew, wheat sheath blight, wheat leaf blight, wheat cyst nematode disease, and other common fungal diseases in crops.

6. The use according to claim 4, wherein the use is used for preventing and controlling wheat scab and wheat stem base rot disease caused by Fusarium.
